(19) United States
(12) Patent Application Publication
(10) Pub. No.: US 2026/0273996 A1
(43) Pub. Date: Sep. 17, 2026

(54) REFRACTIVE IMAGE REVEAL COMPOSITE

(71) Applicant: ROBERT J MABBOTT, BRADENTON, FL (US)

(72) Inventor: ROBERT J MABBOTT, BRADENTON, FL (US)

(21) Appl. No.: 19/665,088

(22) Filed: May 1, 2026

Related U.S. Application Data
(63) Continuation-in-part of application No. 18/230,735, filed on Aug. 7, 2023, now abandoned.

(51) Int. Cl. B44F 1/10; B32B 7/12; B32B 27/32; B32B 27/36

(52) U.S. Cl. CPC B44F 1/10; B32B 7/12; B32B 27/32; B32B 27/36; B32B 2255/10; B32B 2255/20; B32B 2307/518; B32B 2307/7376

(57) ABSTRACT

A multi-layer composite imaging system for selective image reveal and method of manufacturing same, said system having a base substrate with a primary graphic layer printed on at least one surface, a transparent carrier film laminated over said primary graphic layer via an intervening adhesive layer, a microporous coating disposed on the upper surface of said transparent carrier film, said coating comprising a matrix of inorganic particles and a binder defining a plurality of interstitial voids, wherein said coating is substantially opaque in a dry state and a secondary graphic layer printed upon said microporous coating, wherein said secondary graphic layer comprises line art registered to the contours of said primary graphic layer.

### CROSS REFERENCE TO RELATED APPLICATION

This application is a continuation in part of patent application Ser. No. 18/230,735 filed August 7, to which it claims the benefit of priority and which is incorporated by reference.

### FIELD OF THE INVENTION

The present invention relates generally to optical shuttering systems and selective image reveal substrates. More particularly, the invention relates to a multi-layer composite material that utilizes a dry-state opaque microporous coating capable of undergoing a localized, reversible or permanent transition to a transparent state via refractive index matching with a liquid medium.

The invention specifically pertains to the following technical domains:
Adaptive Optical Interfaces: Systems that utilize the physical displacement of air within a nanoporous or microporous matrix to alter the light-scattering properties of a coating, effectively functioning as a “fluid-activated optical gate.”
Laminated Imaging Composites: Multi-layered structures comprising a pre-printed base substrate and a functionalized secondary film assembly, incorporating transparent polymer carriers (such as PET or BOPP) and pressure-sensitive adhesives (PSAs) engineered for optical clarity.
Mess-Free Artistic and Educational Media: Non-staining, “inkless” substrates designed for use with colorless fluid applicators, where the high-fidelity color is pre-existing but concealed by an integrated obscuration layer, until activated by a matching solvent or oil.
High-Precision Graphic Registration: The field of multi-pass or multi-substrate printing where a top-level “guide image” (e.g., vector line art) is spatially synchronized with an underlying “target image” (e.g. full color photo quality +300 dpi) across distinct material interfaces.
Chemical and Physical Fluid Management: substrates specifically engineered to absorb and stabilize non-aqueous, low-volatility fluids (such as Medium Chain Triglycerides) without compromising the structural integrity, “lay-flat” characteristics, or archival quality of the base substrate.
Refractive Index (RI) Tunable Coatings: The formulation of inorganic pigment matrices (silica/alumina) designed to match the specific RI of non-polar lipids and oils to achieve maximum transparency and to then remain transparent after saturation.

### BACKGROUND OF THE INVENTION

The primary object of the present invention provides a technical solution for high-fidelity, mess-free imaging that circumvents the resolution, color gamut, and structural saturation limitations of traditional chemical-chromogenic (leuco dye) or hydro-chromic (water-reveal) technologies.

In order to fully understand and appreciate the present invention, a historical review of the area of technology of this invention is helpful.

### the Evolution of Mess-Free Imaging

For decades, the consumer market for children's arts and crafts has sought a “holy grail”: a system that provides the vibrant, high-fidelity experience of traditional painting and markers without the associated risk of staining skin, clothing, or household surfaces. While several technologies have attempted to fill this void, they each suffer from a fundamental trade-off between mess and image quality.

### Technical Limitations of Chromogenic (Chemical) Systems

The most prevalent mess-free technology relies on a chemical reaction between a colorless leuco dye (in a marker) and a developer coating (on the paper).
The “Bleed” Problem: Because the color is generated in situ through a liquid-phase reaction, the chemistry naturally diffuses through the paper fibers. This lateral migration makes it impossible to achieve sharp edges, fine lines, or the high-resolution detail required for “photo-quality” images.
Chromic Latency: There is a distinct “lag” between application and color appearance, which breaks the intuitive feedback loop for the user.
Color Gamut Ceiling: Users are limited to the specific chemical markers provided; they cannot achieve the complex shading, gradients, or the millions of colors found in a standard CMYK photographic print.

### Technical Limitations of Hydro-Chromic (Water-Reveal) Systems

Other systems use a screen-printed, opaque white “masking” layer that becomes translucent when wet with water. °Structural Instability: Introducing water to a cellulosic (paper) substrate causes the fibers to swell, leading to “cockling” or permanent warping of the page.
The “Ghosting” Effect: These coatings are often not fully opaque in their dry state, allowing the hidden image to peek through. Conversely, once used, they often fail to return to full opacity, leaving a “ghosted” or messy appearance.
Coarse Visuals: Because these coatings are thick and often brittle, they cannot support high-resolution “coloring page” line art on their surface without cracking or flaking.

### The “Optical Shutter” Requirement

There exists a significant technical gap for an imaging system that can conceal a pre-existing, full-color photo quality image behind a stable, professional-grade barrier that can be “opened” instantaneously. Prior art has failed to provide a solution that combines the dimensional stability of polymer films with the optical clearing properties of refractive-index-matched microporous coatings.

The present invention solves these problems by decoupling the image generation (pre-printed at high resolution) from the reveal mechanism (a physical-optical change in a secondary laminated layer), ensuring a mess-free experience that finally achieves professional archivable, photographic results.

### SUMMARY OF THE INVENTION

The present invention provides a multi-layer composite imaging system designed to selectively conceal and reveal high-definition, photo-quality images through the targeted application of a refractive-index-matching fluid. Unlike traditional mess-free systems that rely on chemical color precursors (Leuco dyes) or water-sensitive coatings, the present invention utilizes a mechanical-optical “shutter” mechanism integrated into a stable, laminated structure.

### Technical Architecture

At its core, the invention comprises a rigid or semi-rigid base substrate pre-printed primary graphic layer with a photo quality image (the “hidden image”). To protect this image and provide a functional surface for the reveal mechanism to take place a clear adhesive film coated with the optical “shutter” mechanism is laminated onto the base. This film consists of a transparent polymer carrier (PET or BOPP) which acts as an internal moisture and oil barrier, preventing the revealing fluid from saturating the base paper and causing structural warping or “cockling.” It also enables traditional coloring tools, to be used on the same surface, e.g. using colored pencils, paints and markers.

### The Optical Shutter Mechanism

The functional “shutter” is a microporous inkjet coating applied to the top surface of the clear self-adhesive film. This coating is engineered with a high concentration of inorganic particulates (silica and alumina) and a minimal binder ratio, creating a dense network of air-filled voids. These voids scatter incident light, rendering the layer opaque white and effectively hiding the primary graphic beneath it.

### Dual-Layer Registration

A key feature of the invention is the secondary graphic layer-a line-art coloring guide—printed directly onto the microporous coating. This layer is mathematically registered to the contours of the underlying hidden image. This allows a user to choose whether or not to “color” exactly within the lines of a simple drawing to reveal a perfectly aligned, photo-quality version of that same image.

### The Refractive Reveal

The system is activated by a colorless marker (preferably using capillary action with a conical nib) containing a specific fluid medium, which may be that of a Medium Chain Triglycerides (MCT oil), or alternatively a fluid medium based on a Leuco Dye. Upon contact, the fluid is pulled into the microporous matrix via capillary action, displacing the air. Because the refractive index of the MCT oil or Leuco Dye is tuned to match the refractive index of the silica/alumina particles, the light-scattering effect is neutralized. The coating transitions from opaque to transparent, allowing the hidden high-resolution image to become visible through the clear film carrier and adhesive layers.

### Unique Advantages

Traditional Coloring Tools: The use of a clear self-adhesive carrier film coated with a white microporous inkjet coating which film acts as an internal moisture and oil barrier, ensures that the surface does not warp or cockle, enables the use of traditional coloring tools, e.g. colored pencils, paints and markers to be used on the same surface, with or without the use of the oil filled capillary action marker, necessary to affect the “reveal”.
High Fidelity: By separating the “color” (pre-printed) from the “reveal” (the capillary action marker), the system achieves full color photo quality results impossible with traditional reactive inks.
Permanence & Stability: The non-evaporative nature of the MCT oil provides a stable, long-lasting reveal that does not fade out like water-based “wet reveal” systems.

### DETAILED DESCRIPTION OF THE DRAWINGS

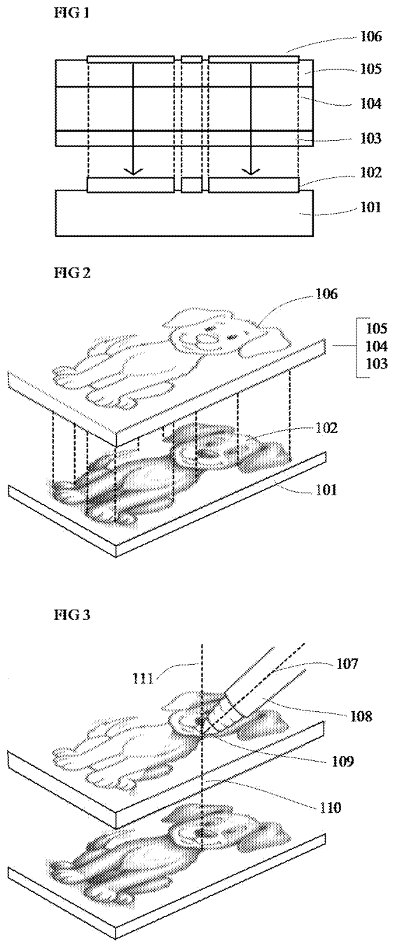

FIG. 1 is an exploded side view of a multi-layer composite imaging system of the present invention;

FIG. 2 is a perspective view of the multi-layer composite imaging system of the present invention with a selective image; and

FIG. 3 is a perspective view of the multi-layer composite imaging system of the present invention in usage.

The following numerical references correspond to the layers and components illustrated in FIGS. 1 through 3.

### FIG. 1 Layer-by-Layer Specifications (FIG. 1: Initial State)

1. Base Substrate (101): A foundational layer comprising a high-opacity cellulosic paper or synthetic substrate (e.g., polypropylene). In a preferred embodiment, this layer has a thickness of 100 μm to 250 μm.
2. Primary Graphic Layer (102): A high-resolution, full-color (CMYK) image printed via offset, flexographic, or digital means directly onto the base substrate (101). This layer represents the “hidden” photo-quality image, ideally exceeding 300 DPI.
3. Pressure-Sensitive Adhesive (103): A clear, non-yellowing acrylic or rubber-based adhesive layer with a thickness of 15 μm to 30 μm. It must possess high optical clarity and be chemically inert to the fluid medium (107).
4. Transparent Carrier Film (104): A structural polymer layer, such as Biaxially Oriented Polypropylene (BOPP) or Polyethylene Terephthalate (PET), with a thickness of 30 μm to 60 μm. This serves as the bridge between the hidden image and the functional coating.
5. Microporous Coating (105): The functional “optical shutter” layer, typically 60 μm to 90 μm thick. It consists of inorganic silica or alumina particles (pore size approx. 10-100 nm) preferably held in a polyvinyl alcohol (PVA) or latex binder. Its high void volume creates a white, opaque appearance in its dry state.
6. Secondary Graphic Layer (106): A “coloring page” line-art image printed onto the surface of the microporous coating (105). This layer is registered with sub-millimeter precision to the contours of the Primary Graphic Layer (102).

### Graphic Registration (FIG. 2: )

Illustrates the registration between the Secondary Graphic Layer (106) and the Primary Graphic Layer (102). The line art (e.g., the outline of a character) is positioned such that when the user applies the marker inside or outside the boundaries of the lines, the corresponding-colored portion of the photo-quality image is revealed, creating the illusion of “painting” in high resolution.

### Mechanism of Action (FIG. 3: Reveal State)

Fluid Medium (107): A colorless low-viscosity liquid (e.g., MCT oil) delivered by a capillary action marker (108) with a conical nib (109).
Saturated Zone (110): Upon contact, the fluid (107) enters the voids of the microporous coating (105) via a capillary action marker. By replacing the air with the fluid (refractive index), the light scattering is eliminated.
Optical Path (111): In a saturated state, the coating (105) turns transparent, letting light travel through the clear film layer (104) and the (PSA) adhesive layer (103), to reflect off the Primary Graphic Layer (102), and reach the viewer's eye.

### DETAILED DESCRIPTION OF THE EMBODIMENTS

### Embodiment 1: the Base Substrate and Primary Graphic

The Base Substrate (101) is preferably a 120 gsm high-brightness clay-coated paper. The Primary Graphic (102) can be printed using both desktop and production printing equipment. The image is for example; a full color photo quality image, that provides a “reward” for the user that exceeds the visual quality of standard line art.

### Embodiment 2: the Optical Bridge (Adhesive and Carrier)

The Transparent Carrier Film (104) is a 30-60 micron PET film. PET is selected for its high dimensional stability, which prevents the “Secondary Graphic” from shifting out of alignment during the drying process of the coating. The Adhesive (103) is a high-clarity, non-yellowing permanent acrylic. It must be applied at a coat weight sufficient to “wet out” any texture on the base substrate, eliminating micro-air pockets that would otherwise create permanent “haze” in the revealed image.

### Embodiment 3: the Microporous “Optical Shutter” Coating

The Microporous Coating (105) is formulated to have a “Void Volume” of 50% to 70%.
The Particle Matrix: In this embodiment, the coating utilizes a blend of fumed silica with a primary particle size of 7 nm to 40 nm, aggregated into larger clusters of 100 nm to 300 nm.
The Opacity Mechanism: These clusters create a complex network of air-filled interstitial voids. Because the size of these voids is within the wavelength range of visible light, they cause intense Mie scattering, making the coating appear brilliant white and 95%+ opaque.
The Transition: When the Fluid Medium (107)—specifically MCT oil with a viscosity of 25-35 cPs—is applied, it is pulled into these nanometer-scale voids by capillary pressure exceeding 2.0 MPa. The air is displaced, and the “shutter” opens.

### Embodiment 4: the Registered Secondary Graphic

The Secondary Graphic (106) is an inkjet-receptive black pigment ink. In a preferred embodiment, the line weight of this graphic is between 0.5 pt and 2.0 pt. This thickness is strategically chosen to mask any minor “registration drift” (up to 0.3 mm) between the top coloring guide and the high-resolution image below, ensuring the user always feels they are coloring “perfectly.”

### Embodiment 5: the Fluid Delivery System (the Marker)

The system includes a marker utilizing a polyester fiber nib with a porosity of between 60% and 75%. The reservoir is filled with a stabilized Medium Chain Triglyceride derived from coconut or palm kernel oil. Unlike water, the MCT oil has a very low vapor pressure, meaning the “revealed” image will stay transparent for several hours or days, providing a long-lasting “finished” look without archival finishes being applied or paper warping that associated with water-reveals.

It is to be understood that while a preferred embodiments of the invention have been described, it is not to be limited to the specific form or arrangement of parts herein described and shown. It will be apparent to those skilled in the art that various changes may be made without departing from the scope of the invention and the invention is not to be considered limited to what is shown and described in the specification and/or drawings.

What is claimed is:

1. A multi-layer composite imaging system for selective image reveal, comprising:
(a) a base substrate having a primary graphic layer printed on at least one surface;
(b) a transparent carrier film laminated over said primary graphic layer via an intervening adhesive layer;
(c) a microporous coating disposed on the upper surface of said transparent carrier film, said coating comprising a matrix of inorganic particles and a binder defining a plurality of interstitial voids, wherein said coating is substantially opaque in a dry state; and
(d) a secondary graphic layer printed upon said microporous coating, wherein said secondary graphic layer comprises line art registered to the contours of said primary graphic layer.

2. The system of claim 1, further comprises a colorless fluid medium having a refractive index between 1.42 and 1.49, characterized in that the application of said fluid medium to the microporous coating fills said interstitial voids to substantially eliminate light scattering, thereby rendering the coating transparent and revealing the primary graphic layer.

3. The system of claim 2, wherein the colorless fluid medium comprises medium chain triglycerides (MCT).

4. The system of claim 1, wherein the inorganic particles of the microporous coating are selected from the group consisting of fumed silica, precipitated silica, and alumina, having a primary particle size between 7 nm and 400 nm.

5. The system of claim 1, wherein the transparent carrier film comprises a polymer selected from the group consisting of (BOPP) and Polyethylene Terephthalate (PET), having a thickness between 15 μm and 50 μm.

6. The system of claim 1, wherein the primary graphic layer is a multi-color image with a resolution of at least 300 dots per inch (DPI).

7. The system of claim 1, wherein the secondary graphic layer is an inkjet-printed pigment ink containing a cationic fixing agent to prevent ink migration upon contact with an oil-based fluid.

8. A method for manufacturing a mess-free imaging composite, comprising the steps of:
(i) printing a primary image on a base substrate;
(ii) laminating a transparent carrier film over said primary image using a clear adhesive;
(iii) applying a microporous coating to the carrier film, said coating having a refractive index matching that of a target reveal fluid; and
(iv) printing a secondary image on said microporous coating using an automated registration system to align said secondary image with the underlying primary image.

9. The method of claim 8, wherein the automated registration system compensates for web stretch or lamination drift to maintain a registration tolerance of ±0.3 mm or less.

10. A mess-free coloring kit comprising:
(a) the multi-layer composite of claim 1; and
(b) a capillary-action marker containing a colorless oil, wherein said oil has a refractive index substantially matching the refractive index of the inorganic particles within the microporous coating.
